(19) United States
(12) Patent Application Publication
(10) Pub. No.: US 2015/0235300 A1
(43) Pub. Date: Aug. 20, 2015

(54) METHOD AND SYSTEM FOR ORDERING AND PURCHASING PRODUCTS VIA A COMMUNICATION CHANNEL

(71) Applicants: Sandor Ambrus, Budapest (HU); Sandor Marti, Budapest (HU)

(72) Inventors: Sandor Ambrus, Budapest (HU); Sandor Marti, Budapest (HU)

(21) Appl. No.: 14/466,178

(22) Filed: Aug. 22, 2014

(30) Foreign Application Priority Data
Feb. 14, 2014 (HU) P1400074

(51) Int. Cl. G06Q 30/06; G06Q 20/32

(52) U.S. Cl. CPC G06Q 30/0635; G06Q 30/0641; G06Q 20/322

(57) ABSTRACT

In a system and method for ordering and purchasing of products displayed in a shop via a communication channel, individual virtual labels to the products displayed in the real space of the shop are provided for clear-cut identification, product information is linked to the virtual label of a data package relating to the given product, and this product information data package is stored in the storage part-unit of a central information technology device so that it can be searched for and displayed while shopping.

The subject of the invention relates to the ordering and purchasing of products displayed in a shop via a communication channel, during which we allocate individual virtual labels to the products displayed in the real space of the shop for clear-cut identification, we link a product information data package to the virtual label relating to the given product and this product information data package is stored in the storage part-unit of a central information technology device in a way so that it can be searched for and displayed, while shopping we view the products displayed in the real space of the shop, we call up the product information data packages relating to them, assess these, then we purchase the selected product in the real space of the shop.

The subject of the invention also relates to a set of equipment for the performance of ordering and purchasing the products displayed in the real space via an information communication channel, e.g. for purchasing products available on a shop on the Internet, which contains a central information technology device, a storage part-unit associated to the central information technology device, as well as product information data packages that can be stored on the storage part-unit at least temporarily and virtual labels suitable for identifying the product information data packages.

As a consequence of the development of information technology networks and the Internet, Internet shopping has become increasingly widespread. The essence of this is that the seller offers the products it wishes to sell to those interested through the Internet on a shopping page. The shopper may select the product that seems suitable for him/her from among the goods displayed on the Internet and then pays its purchase price to the seller using an electronic payment solution or by wire transfer. Among others, such a solution may be seen in publication document number US 2014/0025536.

In publication document number KR 20130084274 we can find out about a “webshop” that displays a three-dimensional picture on the shopper's screen, so creating the feeling that the shopper is moving around an actual store performing the shopping activity.

A significant disadvantage of these electronic purchases is, however, that the shopper cannot hold the product that promises to be interesting for him/her, is unable to try it out in real life, therefore the purchase involves numerous uncertainty factors.

From the point of view of stores selling products in real sales areas, electronic shopping is disadvantageous because some potential shoppers, even if they visit the point of sale, are only able to purchase the product they have tried out at the indicated price, which, in most cases, is higher than the price advertised on the Internet. So a careful customer may be able to view the product at the real point of sale, i.e. in the shop, but in numerous cases he/she will carry out the purchase representing income for the seller at another trader operating on the Internet, which may lead to the reduction of the turnover of real stores and shops, and, in a given case, may lead to the shops closing down.

Patent application number HU P 10 00290 presents an auxiliary device that the customer may use during shopping in a store to rationalise expenses. While patent application number HU P 11 00732 relates to a solution that makes it possible to handle special offer coupons electronically.

A deficiency of the known solution is that they either only provide technical possibilities assisting shopping that can be used on the occasion of making electronic purchases, or those that can only be used at the given place and time when shopping in a shop. The disadvantage of the former is the lack of the real display of the product and the ability to try it out, while the disadvantage of the latter is the great deal of restriction of the possibility of making a reduced-price purchase and the loss of the possibility of comparison.

While from the point of view of shop trading, the disadvantage is the reduction in turnover due to the loss of the possibility of giving a personalised price reduction. Furthermore, the problem that there is insufficient feedback from a customer going into a shop about what products they would be more interested in and, with this, they could “point out” to the operator of the commercial unit what products they should keep on the shelves, which could result in greater turnover.

Our aim with the solution according to the invention was to overcome the deficiencies of the known solutions that assist and simplify shopping and create a set of equipment that primarily in real space, i.e. in the case of shopping in stores, creates the possibility for the shopper to be able to “take with him/her” information in connection with the viewed products when he/she leaves the store, but even after leaving the store for it to be still possible to make contact with the potential customer for the purpose of providing personalised price reductions and providing and obtaining supplementary information, and so to make it possible to use the Internet and other electronic shopping support instruments in shop trading as well.

The recognition that led to the solution according to the invention was that if an identifier is allocated to products displayed in real space, and so can be directly tried out, to which we add data that also includes novel information, and if we add novel elements to the usually used information technology devices to create the possibility of accessing these data, then it becomes possible for a customer leaving a trading unit with the experience gained there to remain in contact with the sales unit and even in an interactive way, move over to essentially electronic shopping, enjoying all of its advantages, and become a customer of the given shop without carrying out the actual purchase when visiting the store, and so the problem may be solved.

On the basis of the above, the idea behind the invention included that if we associate the “virtual shopping cart” generally used during Internet shopping for collecting and listing the products to be purchased with the customer and not with the Internet trader, as is usual, and if we make it possible to connect products to this virtual shopping cart that can be uniquely identified by the various traders not just on the Internet but also in showrooms and stores operating in real space, and, furthermore, if we use this same virtual shopping cart to make point of sale information in connection with the collected products available and then realise contact with the points of sale, then as a result of its unique information technology situation, the given virtual shopping cart is suitable for performing selection, identification, information saving and archiving, and seller communication in a way only and exclusively associated with the customer, then with its help the objective may be realised.

In accordance with the set objective the set of equipment according to the invention for the performance of ordering and purchasing products displayed in real space via an information communication channel, e.g. for purchasing products available on a shop on the Internet—which contains a central information technology device, a storage part-unit associated to the central information technology device, as well as product information data packages that can be stored on the storage part-unit at least temporarily and virtual labels suitable for identifying the product information data packages—is set up in such a way that, on the one hand, the info-communication device belonging to a person interested in a product displayed in a real space may have a collecting area, and, on the other hand, at least some of the products displayed in the real space are supplemented with unique physical labels, where at least a part of the data content of the unique physical labels is the same as at least a part of the data content of a virtual label suitable for identifying product information data packages, furthermore, at least a part of the data content of the unique physical label linked to at least some of the products displayed in real space contains address information and/or name information suitable for clear identification of the real space serving to display the given product, and the unique collecting area is set up so that it is suitable for at least temporarily accepting and storing the data content of the unique physical labels.

A further feature of the set of equipment according to the invention may be that the info-communication device belonging to the person interested in the product displayed in the real space is set up to be capable of data transfer via the information communication channel with the central information technology device.

In the case of a possible embodiment of the set of equipment, the info-communication device is set up to be suitable for inputting the unique physical label data belonging to the given product and for transmitting it to the unique collecting area associated with the interested person. Furthermore, the info-communication device has a data input part-unit, and the data input part-unit has an alphanumeric signal generator and/or optical reader and/or acoustic signal processor.

From the point of view of the invention it may be favourable if the info-communication device is a co-called smartphone.

In the case of another different embodiment of the set of equipment, the product information data package contains technical information and/or economic information.

In the case of a yet again different embodiment of the invention, the unique collecting area is located in the storage part-unit associated with the central information technology device and there it is made to clearly correspond to the interested person.

In accordance with the set aim the procedure according to the invention for ordering and purchasing products displayed in shops via an information communication channel—during which we associate individual virtual labels to the products displayed in the real space of the shop, we link product information data packages relating to the products to the virtual labels and then we store these product information data packages in the storage part-unit of the central information technology device so that they may be searched for and displayed, when making a purchase we inspect the products displayed in the real space of the shop, we call up the product information data packages relating to them, assess these, then we purchase the selected product in the real space of the shop—is based on the principle that beside the virtual label identifying the product information data package for the given product, we associate a unique physical label also including address information and/or name information of the shop containing the real space to the products displayed in the real space of the shop, and we display the unique physical label next to the given product in a way so that it can be accessed, while shopping we record the unique physical label belonging to the given product using the info-communication device and store it at least temporarily in the unique collecting area that is only accessible to the interested person preparing to make a purchase, we repeat these operations as many times as we desire, then assess and analyse the unique physical labels stored in the unique collection area in a given case at a large distance from the real space of the shop, and the actual purchase is carried out in the usual way electronically, via an information communication channel using the information appearing in the unique physical label of the finally selected product.

A further feature of the procedure according to the invention may be that we make it possible for the trader offering the products to access the unique physical label located in the unique collecting area belonging to the interested person and only with respect to the unique physical label belonging to the trader, and then we send the unique offer created by the trader to the interested person via an information communication channel while the interested person is still in the product selection phase.

In the case of a possible realisation of the procedure we make it possible for the trader offering the product to access the unique physical label located in the storage part-unit of the central information technology device and only belonging to the trader, and in this way we send the unique offer created by the trader to the interested person while the interested person is still in the phase of selecting the product via the information communication channel.

The set of equipment according to the invention and the procedure that can be carried out with it have numerous advantageous characteristics. The most important of these is that by using the set of equipment a direct connection may be made between the products of traditional stores displayed in real space and virtual Internet trading, making it possible for the points of sale operating in real space to exploit all the advantages that to date only Internet trading had.

A further advantage is that the set of equipment according to the invention does not require a significant transformation being carried out on the available resources and hardware devices, with a minimal investment a system may be created in which practical and effective operation may be realised.

Another advantage that must be listed is that when using the set of equipment the shops using traditional sales solutions essentially also become electronic sales points as well, which may significantly increase their sales potential and increase their turnover and sales revenue.

Another advantage is that as a result of using the set of equipment the operator of the point of sale may gain access to a great deal of information about customer habits and interests, the analysis of which may provide assistance in the operation of the store. Furthermore, it provides the opportunity to the trader to offer a personalised price reduction to the customer who has still only placed the shop product into his/her virtual shopping cart for storage purposes to encourage the actual purchase in the interest of the purchase being made in the sphere of interest of the trader.

The significant economic advantage deriving from this for the trader using it is that the use of the set of equipment extends the possibilities of traditional shop trade and sales, and makes it possible for the shop trader to find a way to “keep the shopping power in the store” even in when a potential customer is leaving the store.

An advantage of the solution according to the invention for the customer is that by using the set of equipment he/she can collect all those products that he/she is interested in and then place the products viewed and tried out in real life in the shop onto a list of competing products among which he/she only has to choose the one to be purchased later on, in calmer circumstances, and after making the decision he/she does not have to go back to the given shop, instead he/she can purchase the products displayed in the given shop via remote access. To date the known solutions have not been able to provide this service at all.

In the following we present the set of equipment according to the invention in more detail on the basis of construction examples, on the basis of a drawing. On the drawing

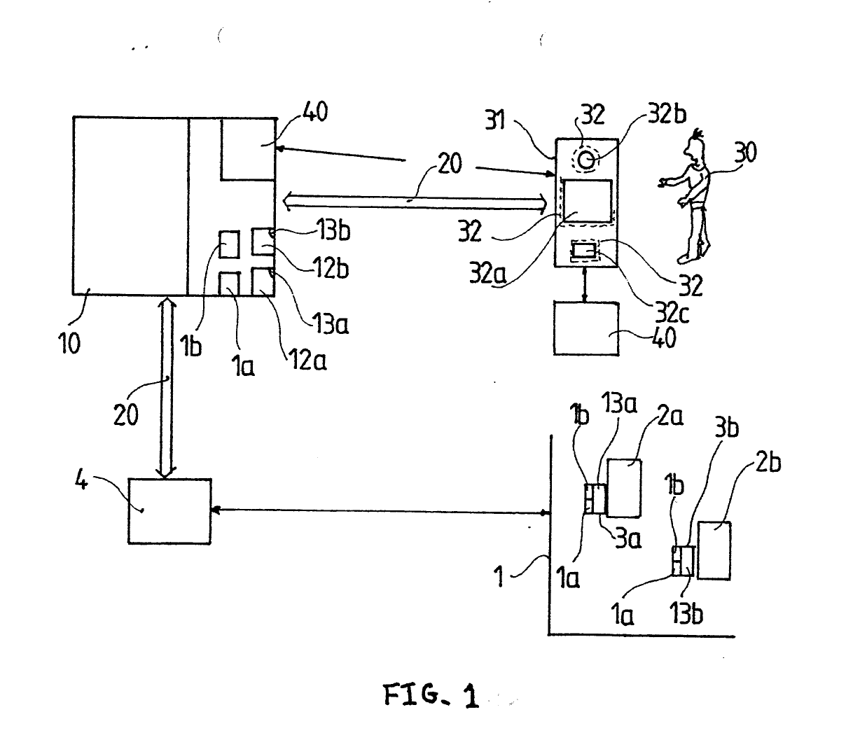

FIG. 1 is a picture presenting the positions and connections of a possible version of the set of equipment according to the invention.

On FIG. 1 an embodiment of the set of equipment according to the invention may be seen that illustrates the individual connected elements with the presentation of their positions and connections as compared to each other. It may be observed that both product 2a and product 2b in the real space 1 destined for sale have a unique physical label 3a and a unique physical label 3b.

This unique physical label 3a and unique physical label 3b may be an alphanumerical character group placed on the price label next to the product, or a mark produced in another way that the interested person 30 records in some way with the help of the info-communication device 31 belonging to the interested person 30 onto the unique collecting area 40 allocated to the interested person 30.

The info-communication device 31 belonging to the interested person 30 has a data input part-unit 32 for inputting the unique physical label 3a and the unique physical label 3b, which may be an alphanumerical signal generator 32a, so, for example, a touch screen or keyboard, or even an optical reader 32b, e.g. camera, but it may also be an acoustic signal processor 32c, e.g. microphone, with the associated supplementary electronic elements.

FIG. 1 also shows that the unique physical label 3a belonging to the product 2a includes the address information 1a belonging to the real space 1, and, here, the name information 1b as well, with the help of which later on the product 2a trader's 4 contact data may be called up. Apart from the address information 1a and the name information 1b, the unique physical label 3a also includes the virtual label 13a. The purpose of the virtual label 13a is to make the product information data package 12a belonging to the product 2a accessible with the help of the unique physical label 3a, which is located in the storage part-unit 11 of the central information technology device 10 also accessible to the trader 4.

Naturally, the unique physical label 3b of the product 2b also contains the address information 1a, the name information 1b of the real space 1, as well as that virtual label 13b with the help of which the product information data package 12b relating to the product 2b located in the storage part-unit 11 of the central information technology device 10 may be downloaded.

The trader 4 offering product 2a and product 2b for sale may get in contact with the storage part-unit 11 of the central information technology device 10 with the help of the information communication channel 20, and may upload to there the product information data package 12a relating to the product 2b. In the same way the trader 4 may place the address information 1a and the name information 1b into the storage part-unit 11 of the central information technology device 10, which, after this, the interested person 30 may download from the storage part-unit 11 of the central information technology device 10 via the information communication channel 20 with the help of his/her info-communication device 31.

With the help of his/her own info-communication device 31 the interested person 30 may download the product information data package 12a identified with the virtual label 13a and the product information data package 12b identified with virtual label 13b placed in the storage part-unit 11 of the central information technology device 10, in the knowledge of the unique physical label 3a associated with the given product 2a or the unique physical label 3b associated with the product 2b via the information communication channel 20, and also with the help of the info-communication device 31 he/she may store this on his/her unique collecting area 40. He we must note that it is not absolutely necessary for the unique collecting area 40 to form a part of the interested person's 30 info-communication device 31. It can be imagined that the unique collecting area 40 is located in the storage part-unit 11 of the central information technology device 10. What is more, it may also be that the unique collecting area 40 is set up in a completely independent information technology device—not indicated in FIG. 1.

Here we must also remark that the unique physical label 3a and the unique physical label 3b belonging to product 2a and product 2b may be displayed virtually, or, for example, duplicated using printing technology and then placed on a physical carrier, e.g. paper sheet, next to the product 2a or the product 2b. The unique physical label 3a and the unique physical label 3b, apart from being alphanumerical characters, may be a barcode or QR code, which can only be read using an information technology device.

In the case of this example the info-communication device 31 is favourably a so-called smartphone, but it may also be any suitable computer technology device, an iPod, laptop, tablet or similarly easily portable and operated low-weight device on which computer technology applications are running. What is more, if the unique physical label 3a of product 2a and the unique physical label 3b of product 2b are printed out on a removable carrier, then the info-communication device 31 belonging to the interested party 30 may even be a desktop computer as well.

In the following we present the procedure according to the invention that can be performed with the presented set of equipment in more detail in connection with examples.

### EXAMPLE 1

In the case of this version of the procedure according to the invention we have put together the product information data package 12a related to product 2a and the product information data package 12b related to product 2b displayed for sale in the real space 1 operated by the trader 4 as a business, and these were loaded into and stored on the storage part-unit 11 of the central information technology device 10 using an information technology solution known in itself with the help of the information communication channel 20 so that we associated virtual label 13a to the product information data package 12a belonging to product 2a while we associated virtual label 13b to the product information data package 12b belonging to product 2b.

Apart from this, we placed a printed out unique physical label 3a that may be picked up and taken away by the interested person 30 next to the product 2a on which, in the form of alphanumerical characters, we recorded the virtual label 13a, furthermore, the address information 1a and the name information 1b of the trader 4 operating the real space 1 displaying the product 2a. While we also placed a printed out unique physical label 3b that may be picked up and taken away by the interested person 30 next to the product 2b on which, in the form of alphanumerical characters, we recorded the virtual label 13b, furthermore, the address information 1a and the name information 1b of the trader 4 operating the real space 1 displaying the product 2b. The data belonging to this address information 1a and name information 1b, e.g. e-mail address, website address, etc. was also loaded into the storage part-unit 11 of the central information technology device 10 and also stored there so that it may be downloaded.

After this, during the procedure during the ordering and purchasing of the products 2a and 2b displayed in the real space, i.e. the shop, via the information communication channel 20 we proceeded as follows. We took the unique physical label 3a of product 2a located in the real space 1 with ourselves and with the help of the info-communication device 31 belonging to the interested party 30, in this example the alphanumerical signal generator 32a forming the data input part-unit 32 of the desktop computer, in this case a keyboard, and inputted it into the info-communication device 31. We repeated the given process in connection with several products 2b identified at different places and times, and so with the help of the info-communication device 31 belonging to the interested party 30 we archived numerous products 2a and 2b onto the unique collecting area 40.

Then using the information communication channel 20 we connected the info-communication device 31 with the storage part-unit 11 of the central information technology device 10 and with the help of the virtual label 13a of the unique physical label 3a inputted into the info-communication device 31, using the info-communication device 31 we downloaded the product information data package 12a belonging to the virtual label 13a from the storage part-unit 11 of the central information technology device 10 via the information communication channel 20, and displayed the product information data package 12a belonging to the product 2a on the info-communication device 31. We repeated the given process with several different products 2b and so with the help of the info-communication device 31 belonging to the interested person 30 we compared the various interesting goods in detail.

After studying the product information data package associated with product 2a we decided to purchase product 2a. After the decision on the basis of the address information 1a and name information 1b of the unique physical label 3a, using the info-communication device 31 and the information communication channel 20, from the address information 1a and the name information 1b placed in the storage part-unit 11 of the central information technology device 10 we determined the relevant data of the trader 4 selling the product 2a and got into contact with the trader 4.

After making contact the trader 4 gave a unique offer using the information communication channel 20, which we accepted and purchased the selected product 2a now at a location remote from the real space 1 on the basis of the usual electronic purchasing process at a different, more favourable price than the price displayed at the product 2a displayed in the real space 1.

### EXAMPLE 2

In this version of the procedure we placed unique physical label 3a and unique physical label 3b created as QR codes on the price label next to product 2a and product 2b offered for sale in real space 1. This unique physical label 3a and unique physical label 3b contained coded the virtual label 13a and the virtual label 13b as well as the address information 1a and name information 1b.

Similarly to that presented in the previous example we loaded the storage part-unit 11 of the central information technology device 10 with the product information data package 12a and with the product information data package 12b as well as with the address information 1a and name information 1b.

While shopping the interested person 30 loaded the QR code of the unique physical label 3b belonging to the selected product 2b into the info-communication device 31 with the help of the optical reader 32b, used as a data input part-unit 32, of the smartphone used as the info-communication device 31 and from there to the unique collecting area 40, where were saved it temporarily. After viewing the various interesting products, using the info-communication device 31 we called up the unique physical labels 3b of the individual products, so of the product 2b, from the unique collecting area 40.

After reading in the unique physical label 3b with the help of the information communication channel 20 we studied the product information data package 12b identified with the virtual label 13b to be found in the storage part-unit 11 of the central information technology device 10, and decided on buying the product 2b. Accordingly, with the help of the address information 1a and the name information 1b to be found in the unique physical label 3b of the product 2b, we loaded the trader's 4 data indicated as operator of the real space 1 from the storage part-unit 11 of the central information technology device 10 via the information communication channel 20 and got into contact with the trader 4.

On gaining knowledge of our purchasing intent the trader 4 drew up a unique offer and sent it to the info-communication device 31 with the help of the information communication channel 20, which we accepted and so performed the purchase of the product 2b.

### EXAMPLE 3

In the given procedure example we have shown the unique physical label 3a and the unique physical label 3b of the given product using alphanumerical characters on an LCD display located beside the product 2a and the product 2b. We inputted the data of the unique physical label 3a of the selected product 2a using live speech into the acoustic signal processor 32c used as data input part-unit 32 of a tablet 32 used as the info-communication device 31, after appropriately converting the acoustic signals received, the info-communication device 31 stored the data of the desired virtual label 13a, the address information 1a and the name information 1b onto the unique collecting area 40—allocated to the info-communication device 31, but in a physically different location—kept separately in the storage part-unit 11 of the central information technology device 10.

Apart from this difference, we performed the procedure according to the invention in the same way as that elaborated in example 1.

The set of equipment and procedure according to the invention may be used to good effect in all places where in traditional shop retail and wholesale trading it is practical to use unique customer service that is usual in Internet trading, and so provide the individual customers with favourable customised offers, and keep the purchasing possibility within the sphere of interest of service providers performing real space sales in such a way that in a given case the purchase itself does not take place at the point of sale and when the purchaser is actually there, but later on in virtual space and according to the given conditions.

### LIST OF REFERENCES

1 real space
1a address information
1b name information
2a product
2b product
3a unique physical label
3b unique physical label
4 trader
10 central information technology device
11 storage part-unit
12a product information data package
12b product information data package
13a virtual label
13b virtual label
20 information communication channel
30 interested person
31 info-communication device
32 data input part-unit
32a alphanumerical signal generator
32b optical reader
32c acoustic signal processor
40 unique collecting area

1-2. (canceled)

3-10. (canceled)

11. A system for ordering and purchasing products displayed in a real space via an information communication channel, comprising:
a central information technology device; and
a storage part-unit associated with the central information technology device;
wherein the storage part-unit at least temporarily stores product information data packages and virtual labels suitable for identifying the product information data packages;
wherein the system further comprises an info-communication device belonging to a person interested in a product displayed in the real space, wherein the info-communication device includes a collecting area for collecting data relative to the product displayed in the real space;
wherein at least some of the products displayed in the real space are supplemented with unique physical labels, and at least a part of the data content of the unique physical labels is the same as at least a part of the data content of virtual labels suitable for identifying product information data packages;
wherein at least a part of the data content of the unique physical labels linked to at least some of the products displayed in the real space contains at least one of address information and name information suitable for clear identification of the real space serving to display the products; and
wherein the collecting area at least temporarily accepts and stores the data content of the unique physical labels.

12. The system of claim 11, wherein the info-communication device belonging to the person interested in the product displayed in the real space performs a data transfer via the information communication channel with the central information technology device.

13. The system of claim 12, wherein the info-communication device belonging to the person interested in the product displayed in the real space inputs the data content of the unique physical label belonging to the product displayed in the real space and transmits it to the collecting area associated with the person interested in the product displayed in the real space.

14. The system of claim 12, wherein the info-communication device includes a data input part-unit, and the data input part-unit comprises an optical reader and/or an alphanumeric signal generator and/or an acoustic signal processor.

15. The system of claim 12, wherein the product information data packages contain at least one of technical information and economic information.

16. The system of claim 12, wherein the collecting area is located in the storage part-unit associated with the central information technology device and the collecting area corresponds to the person interested in the product displayed in the real space.

17. The system of claim 11, wherein the info-communication device belonging to the person interested in the product displayed in the real space inputs the data content of the unique physical label belonging to the product displayed in the real space and transmits it to the collecting area associated with the person interested in the product displayed in the real space.

18. The system of claim 17, wherein the info-communication device includes a data input part-unit, and the data input part-unit comprises an optical reader and/or an alphanumeric signal generator and/or an acoustic signal processor.

19. The system of claim 18, wherein the info-communication device comprises a smart-telephone device.

20. The system of claim 17, wherein the info-communication device comprises a smart-telephone device.

21. The system of claim 17, wherein the product information data packages contain at least one of technical information and economic information.

22. The system of claim 11, wherein the info-communication device comprises a smart-telephone device.

23. The system of claim 22, wherein the product information data packages contain at least one of technical information and economic information.

24. The system of claim 22, wherein the collecting area is located in the storage part-unit associated with the central information technology device and the collecting area corresponds to the person interested in the product displayed in the real space.

25. The system of claim 11, wherein the product information data packages contain at least one of technical information and economic information.

26. The system of claim 25, wherein the collecting area is located in the storage part-unit associated with the central information technology device and the collecting area corresponds to the person interested in the product displayed in the real space.

27. The system of claim 11, wherein the collecting area is located in the storage part-unit associated with the central information technology device and the collecting area corresponds to the person interested in the product displayed in the real space.

28. A method for ordering and purchasing products displayed in a shop via an information communication channel, comprising the steps of:
associating individual virtual labels with products displayed in a real space of the shop;
linking product information data packages relating to the products to the virtual labels;
storing the product information data packages in a storage part-unit of a central information technology device so that they may be searched for and displayed;
during a purchase, inspecting the products displayed in the real space of the shop, calling up the product information data packages relating to the products, and assessing a selected product in the real space of the shop;
wherein, in addition to the virtual label identifying the product information data package for the selected product, a unique physical label includes at least one of address information and name information of the shop containing the real space and the products displayed in the real space of the shop;
said method further comprising the steps of:
displaying the unique physical label next to the given product in such a way that it can be accessed;
recording, during shopping, the unique physical label belonging to the selected product using an info-communication device and storing it at least temporarily in a unique collection area that is only accessible to an interested person preparing to make a purchase;
repeating the steps relating to the purchase as many times as desired and then assessing and analyzing unique physical labels stored in the unique collection area in a given case at a large distance from the real space of the shop; and
completing the actual purchase electronically via the information communication channel using the information appearing in the unique physical label of a finally selected product.

29. The method of claim 28, further comprising the steps of:
providing, to a trader offering the products, access to the unique physical label located in the unique collection area belonging to the interested person, but only with respect to unique physical labels belonging to the trader; and
sending a unique offer created by the trader to the interested person via the information communication channel while the interested person is still in a product selection phase.

30. The method of claim 28, further comprising the steps of providing, to a trader offering a product, access to the unique physical label located in the storage part-unit of the central information technology device, and sending a unique offer created by the trader to the interested person while the interested person is still selecting a product via the information communication channel.
